(19) United States
(12) Patent Application Publication
(10) Pub. No.: US 2010/0323153 A1
(43) Pub. Date: Dec. 23, 2010

(54) PACKAGING MATERIAL

(76) Inventor: Mary Huskey, Manistee, MI (US)

Correspondence Address: ROBERT J. SAYFIE, P.C., 161 OTTAWA AVENUE NW, SUITE 407, GRAND RAPIDS, MI, 49503, US

(21) Appl. No.: 12/488,613

(22) Filed: Jun. 22, 2009

(51) Int. Cl. B32B 3/10; B23P 17/04

(52) U.S. Cl. 428/131; 29/428

(57) ABSTRACT

A packaging material and method for making the material. The material having a member that may be made from a natural growing and biodegradable material, such as a sunflower stalk. The members may be connected to a string so that it is easy to clean if it falls to the ground or is removed from a package or box. The members or sunflower stalk segments may be securely fastened to a string, or they may be slidably disposed on a string. The string is also called a connector. The string or connector may also be biodegradable.

### GOVERNMENT RIGHTS

This invention was not made with Government support under. The Government does not have any rights in this invention.

### BACKGROUND OF THE INVENTION

The present invention is a packaging material that is made from a plant stalk, and is thus renewable, reproducible, and biodegradable.

Currently, Styrofoam is typically used as packaging material because it is light and compressible. Its compressibility allows it to cushion impact so the item being shipped is not damages during transport.

However, Styrofoam is made almost entirely of petroleum products. Styrofoam does not break down over time. It can be recycled, but most recycling stations are not equipped to deal with the amount of Styrofoam that is thrown away across the world each day. Styrofoam can be destroyed if it is incinerated at extremely high temperatures, creating only a small amount of water and carbon as byproducts. However if it is burned in a normal fire instead of in a specialized incinerator, it releases pollutants such as carbon black and carbon monoxide.

Further, individual Styrofoam pieces, typically called “peanuts” make a mess when opening a box, as the pieces may fall all over the floor as the individual peanuts have to be picked up one by one. In addition, when disposed of, they do not decompose, but may remain in a landfill for thousands of years, taking up space and creating pollution.

As can be seen, there is a need for a packaging material that is biodegradable; can be grown naturally, and can be connected on a string, rather than being individual pieces.

### SUMMARY OF THE INVENTION

One aspect of the present invention is a packaging material comprising: a member; and a connecter securing one member to another member.

Another aspect is a packaging material, comprising: a connector; and a biodegradable member disposed on said connector.

Another aspect is a method of manufacturing packaging material (10), comprising the steps of: planting and growing (110) a sunflower stalk; removing (120) the sunflower stalk from the place where it grows;
cutting (130) the sunflower stalk into members (20);
placing (140) the member (20) onto a connector (30).

These and other features, aspects and advantages of the present invention will become better understood with reference to the following drawings, description and claims.

### BRIEF DESCRIPTION OF THE DRAWINGS

FIG. 1 is a pictorial of an embodiment of the present invention;

FIG. 2 is a pictorial of an embodiment of the present invention; and

FIG. 3 is a pictorial of an embodiment of the present invention.

FIG. 4 is a method of manufacturing the present invention.

### DETAILED DESCRIPTION OF THE INVENTION

### Reference Numerals

10 packaging material
20 member
25 end member
30 connector
40 sunflower stalk
50 bore
100 method of manufacturing the present invention
110 planting and growing
120 removing
130 cutting
140 placing

The following detailed description is of the best currently contemplated modes of carrying out the invention. The description is not to be taken in a limiting sense, but is made merely for illustrating the general principles of the invention, since the scope of the invention is best defined by the appended claims.

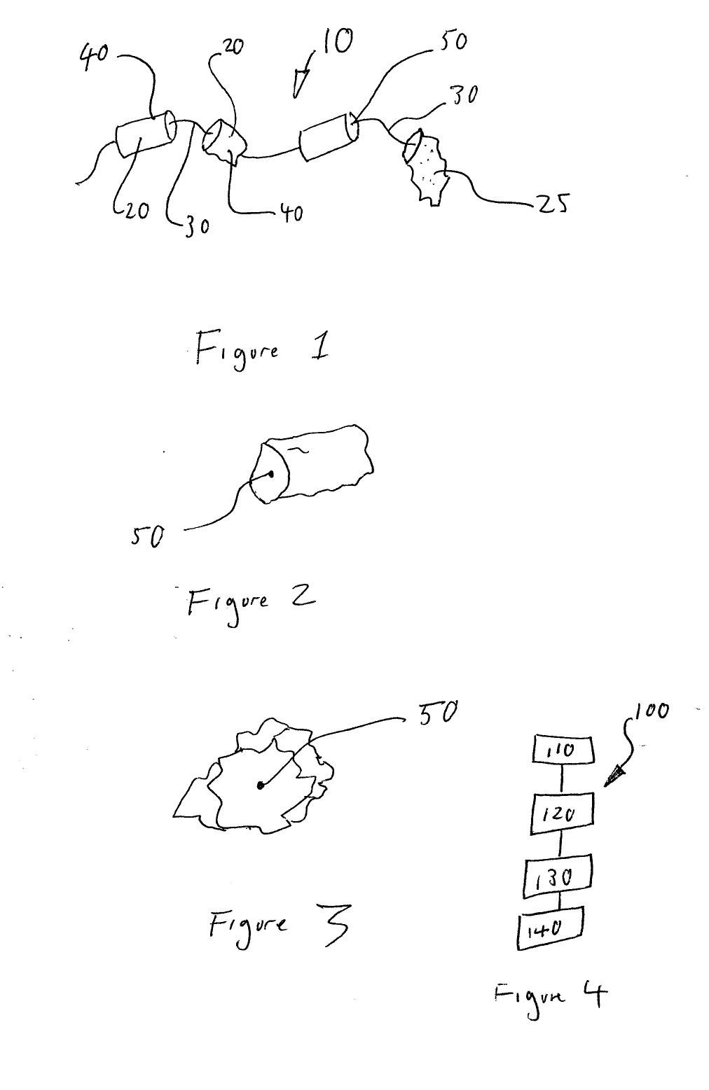

FIG. 1 illustrates an embodiment of the present invention showing a packaging material 10 having a member 20 secured to a connector 30. In one embodiment, the member 20 is connected to a connector 30, and the connector 30 is secured to another member 20. In one embodiment, there are several members 20 secured to the connector 30.

In one embodiment, the connector 30 is made from or of a biodegradable string or string-like material, such as cotton or jute. The connector 30 may be similar to 50-pound kite string. In one embodiment, the connector 30 may have a diameter of about 1/16 of an inch.

In one embodiment, the member 20 is made from or of sunflower stalk 40. The sunflower stalk 40 may also be referred to as Helianthus annuus stalk. The sunflower stalk 40 may include the harder epidermis, or it may be used in the present invention with the epidermis portion removed, which reveals a softer and less dense portion 40 of the stalk 40. Although referred to herein as the stalk 40, this term also includes the softer and less dense portion 40.

In one embodiment, the member 20 may have a diameter of about 3/16 of an inch, and it may have a length of about ½ of an inch.

In one embodiment, the member 20 is made from a naturally growing organism, and is biodegradable.

In one embodiment, the member 20 may have a bore 50 therethrough, and the connector 30 is securely disposed through the bores 50 so that the member 20 does not slide relative to the connector 30. In another embodiment, the member may slide relative to the connector 30.

FIG. 2 illustrates a member 20 having a cylindrical shape and a bore 50 disposed longitudinally therethrough.

FIG. 3 illustrates a non-cylindrically shaped member 20 having a bore therethrough 50.

FIG. 1 illustrates an end member 25, which may be placed at the end of the connector 30.

FIG. 4 illustrates a method of manufacturing the present invention. A method 100 of manufacturing packaging material 10, comprising the steps of planting and growing 110 a sunflower stalk. The next step is removing 120 the sunflower stalk from the place where it grows, which may be a garden or planter. The third step may be cutting 130 the sunflower stalk into members 20. The fourth step may be placing 140 the member 20 onto a connector 30.

In one embodiment, the method 100 may have a member 20 that may be less than about two inches in length. In one embodiment, the method 100 may have a member 20 that is securely located on the connector 30. In one embodiment the method 100 may have a connector 30 that is made of or from biodegradable material.

The connector 30 may be of a variety lengths or diameters. The members 20 may be of a variety of lengths, shapes, and sizes.

The connector 30 having members 20 disposed thereon can be placed in shipping containers as packaging material. If the packaging material 10 of the present invention 10 is removed or falls from the box or shipping container, it 10 can be easily picked up by picking up the connector 30 or string 30, rather than having to pick up the individual members 20.

It should be understood, of course, that the foregoing relates to exemplary embodiments of the invention and that modifications may be made without departing from the spirit and scope of the invention as set forth in the following claims.

I claim:

1. A packaging material (10), comprising:
a member (20).

2. The apparatus (10) of claim 1, further comprising:
said member (20) having a bore (50) therethrough for receiving said connector (30).

3. The apparatus (10) of claim 1, wherein said member (20) is a made from a sunflower stalk (40).

4. The apparatus (10) of claim 1, further comprising: a connector (30) securing one member (20) to another member (20).

5. The apparatus (10) of claim 4, wherein said connector (30) is made from cotton.

6. The apparatus (10) of claim 4, wherein said connector (30) is made from jute.

7. The apparatus (10) of claim 1, wherein said member (20) is made from a biodegradable material.

8. The apparatus (10) of claim 4, wherein said connector (30) is made from a biodegradable material.

9. A packaging material (10), comprising:
a biodegradable member (20).

10. The apparatus (10) of claim 9, wherein said biodegradable member (20) is securely disposed on a connector (30).

11. The apparatus (10) of claim 10, wherein said biodegradable member (20) is slidably disposed on said connector (30).

12. The apparatus (10) of claim 10, wherein said connector (30) is made of a biodegradable string.

13. The apparatus (10) of claim 10, wherein said connector (30) is made from a biodegradable string.

14. A method (100) of manufacturing packaging material (10), comprising the steps of:
planting and growing (110) a sunflower stalk;
removing (120) the sunflower stalk from the place where it grows;
cutting (130) the sunflower stalk into members (20);
placing (140) the member (20) onto a connector (30).

15. The method (100) of claim 13, wherein said members (20) are less than two inches in length.

16. The method (100) of claim 13, wherein said member (20) is securely located on the connector (30).

17. The method (100) of claim 13, wherein said connector (30) is biodegradable material.
